(19) United States
(12) Patent Application Publication
(10) Pub. No.: US 2025/0023604 A1
(43) Pub. Date: Jan. 16, 2025

(54) METHOD AND DEVICE FOR BEAMFORMING

(71) Applicant: MEDIATEK Inc., Hsinchu City (TW)

(72) Inventors: Li-Chieh CHEN, Hsinchu City (TW); Cheng-En HSIEH, Hsinchu City (TW); Wei-Hsu CHEN, Hsinchu City (TW); Ming-Hsiang TSENG, Hsinchu City (TW); Kang-Li WU, Hsinchu City (TW)

(21) Appl. No.: 18/743,353

(22) Filed: Jun. 14, 2024

Related U.S. Application Data
(60) Provisional application No. 63/513,581, filed on Jul. 14, 2023.

(51) Int. Cl. H04B 7/0417; H04B 7/0452; H04B 7/06

(52) U.S. Cl. CPC H04B 7/0417; H04B 7/0452; H04B 7/0626

(57) ABSTRACT

The application discloses a device and method for beamforming. The beamforming method comprises: sending a null data packet announcement (NDPA) frame from a beamformer to a pseudo user and a target user to indicate the target user to prepare for channel estimation; sending a null data packet (NDP) from the beamformer to the target user and performing channel estimation by the target user based on the NDP to determine channel state information; sending a beamforming report poll (BRP) trigger frame from the beamformer to the target user to trigger the target user to feed back channel state information; and sending from the target user a beamforming report to the beamformer, wherein the beamforming report including the channel state information.

This application claims the benefit of U.S. provisional application Ser. No. 63/513,581, filed Jul. 14, 2023, the subject matter of which is incorporated herein by reference.

### TECHNICAL FIELD

The disclosure relates in general to a method and device for beamforming. This disclosure also relates to the field of communications technologies, and in particular, to a channel state information feedback method and an apparatus thereof.

### BACKGROUND

In a wireless communications system such as WiFi or wireless local area network (WLAN), a multiple-input multiple-output (MIMO) technology is a widely used technology. When the MIMO technology is used, a beamformer needs to obtain channel state information from a beamformee, such that the beamformer implements functions such as beamforming, rate control, and resource allocation based on the channel state information.

Now, 802.11 standard is a universal WLAN standard. Currently, the Institute of Electrical and Electronics Engineers (IEEE) is discussing next generation 802.11 standard after 802.11ax. Compared with the previous 802.11 standard, the next generation 802.11 standard supports data transmission with an extremely high throughput (EHT), that is, the next generation 802.11 standard supports a higher bandwidth (for example, 320 megahertz (MHz)) and more streams (for example, 16 spatial streams). In this way, the beamformee needs to feed back more pieces of channel state information to the beamformer, resulting in excessively high feedback overheads. Therefore, for the next generation 802.11 standard, how to feed back channel state information and implement balance between feedback overheads and feedback precision of the channel state information is an urgent problem to be resolved.

Various aspects related to wireless communication, specifically focusing on techniques and protocols related to Transmit Beamforming (TxBF) and Multiple User (MU) MIMO (Multiple-Input Multiple-Output) in the context of the 802.11 standard draft (likely related to Wi-Fi) are discussed.

Transmit Beamforming (TxBF) is a technique that utilizes a training signal to estimate the channel and a steering signal to achieve spatial directivity in wireless communication. The TxBF technique involves sending signals in a way that takes into account the characteristics of the wireless channel to enhance the signal reception at the intended receiver. The training signal helps in estimating the channel conditions, and the steering signal is used to direct the transmission spatially.

According to 802.11 standard, an MU Beamformer shall not solicit an MU feedback in an EHT non-Trigger-Based (TB) sounding sequence. This indicates that in a scenario of Extended High Throughput (EHT) with non-Trigger-based (TB) sounding sequence, an MU Beamformer should not request feedback of MU EHT Compressed Beamforming Report. TB sounding indicates that this sounding sequence is preceded through Trigger-based method (using Beamforming Report Poll trigger frame) or Non-trigger-based method (using legacy Beamforming Report Poll). A beamformer can solicit single-user (SU) type feedback from multiple users in one Non-Trigger-based sounding sequence.

Further, in example showing the frame exchange sequence of trigger-based 2-MU sounding, which shows the sequence of frames exchanged in a trigger-based scenario involving 2 Multiple Users (2-MU) sounding. This refers to the process of initiating communication with two users simultaneously.

Also, to ensure Beamforming and DL (down-link) MU-MIMO quality, re-sounding within a time period is needed. Performing re-sounding (re-evaluating the channel and steering signals) within a specific time period is important to maintain the quality of Beamforming and Downlink (DL) Multiple User-Multiple Input Multiple Output (MU-MIMO) communication.

Also, to obtain MU type feedback for beamforming, it requires TB sounding with multi-users in Null Data Packet Announcement (NDPA) frame. According to 802.11 standard, NDPA comes before Null Data Packet (NDP) to announce that the next about to be sent packet is NDP. To receive feedback suitable for Beamforming from multiple users (MU type feedback), it is necessary to perform TB (Trigger-based) sounding with multiple users within an NDPA frame.

When initiating TB sounding with a need-to-sound station (STA), as in target user, it is necessary to solicit MU feedback from the target user and another STA. Thus, the sounding overhead depends on how frequent the STA with shorter sounding period needs. The frequency of sounding is influenced by the needs of the STA with a shorter sounding period, and this affects the overall sounding overhead (communication resources used for sounding).

Thus, there is a need to optimize sounding overhead.

### SUMMARY

According to one embodiment, a beamforming method is provided. The beamforming method comprises: sending a null data packet announcement (NDPA) frame from a beamformer to a pseudo user and a target user to indicate the target user to prepare for channel estimation; sending a null data packet (NDP) from the beamformer to the target user and performing channel estimation by the target user based on the NDP to determine channel state information; sending a beamforming report poll (BRP) trigger frame from the beamformer to the target user to trigger the target user to feed back channel state information; and sending from the target user a beamforming report to the beamformer, wherein the beamforming report including the channel state information.

According to another embodiment, a beamforming device is provided. The beamforming device comprises: a processor; and a transceiver coupled to the processor. Wherein the processor and the transceiver are configured for: sending a null data packet announcement (NDPA) frame to a pseudo user and a target user to indicate the target user to prepare for channel estimation; sending a null data packet (NDP) to the target user and performing channel estimation by the target user based on the NDP to determine channel state information; sending a beamforming report poll (BRP) trigger frame to the target user to trigger the target user to feed back channel state information; and receiving from the target user a beamforming report, wherein the beamforming report including the channel state information.

### BRIEF DESCRIPTION OF THE DRAWINGS

FIG. 1 shows a multi-user feedback procedure according to one embodiment of the application.

FIG. 2 is a schematic structural diagram of a common NDPA frame.

FIG. 3 shows a schematic structural diagram of an NDPA frame according to an embodiment of this application.

FIG. 4 is a schematic structural diagram of a BRP trigger frame in according to an embodiment of this application.

FIG. 5 shows comparison between the sounding overhead of the prior art and one embodiment of the application.

FIG. 6 shows estimation of sounding overhead of the prior art and one embodiment of the application.

FIG. 7A and FIG. 7B show sounding overhead according to the prior art and one embodiment of the application.

FIG. 8 is a schematic structural diagram of a communications apparatus according to an embodiment of this application.

FIG. 9 is a structural diagram of a possible product form of a communications apparatus according to an embodiment of this application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

One embodiment of the application discloses a trigger-based explicit transmit beamforming with pseudo user to optimize sounding overhead. One primary goal of one embodiment of the application is to optimize sounding overhead, which refers to the resources and time used for the process of determining channel conditions and configuring the transmission for beamforming. Also, in one embodiment of the application, for an MU beamformer initiate TB sounding sequence, it is not necessary to solicit all users identified in the NDP Announcement frame. When a multiple user (MU) beamformer initiates a Trigger-based (TB) sounding sequence, it is not required to request feedback from all users listed in the NDPA (null data packet announcement) frame. In other words, not all users need to be involved in the process of channel estimation and beamforming. Still further, in one embodiment of the application, the beamforming report poll (BRP) trigger frame solicits an MU feedback of the target user with FBW RU (full Bandwidth Resource Unit) allocation, which can reduce sounding overhead. The BRP trigger frame is as a mechanism to request feedback from Multiple Users (MU) regarding the target user. This feedback is associated with FBW RU allocation. The purpose is to reduce the sounding overhead, implying that by selectively soliciting feedback from specific users and allocating resources efficiently, the overall overhead can be minimized. Beamformer (BFer) is the one that sends NDPA, NDP and BFRP (or BRP) and applies beamforming to the data packet physically.

The following first briefly describes some concepts.

### (1) Feedback Procedure of Channel State Information in an 802.11Ax Standard

Currently, feedback procedures of channel state information in the 802.11ax standard are classified into a single-user feedback procedure and a multi-user feedback procedure. The following uses an example in which a beamformer is an access point (AP) and a beamformee is a station (STA) for description.

In the single-user feedback procedure, an AP sends an NDPA frame, to indicate a target STA to prepare for channel estimation. Then, the AP sends a null data packet (NDP), such that the target STA performs channel estimation based on a long training sequence in the NDP, to determine channel state information. The target STA sends a beamforming report to the AP, and the beamforming report includes the channel state information.

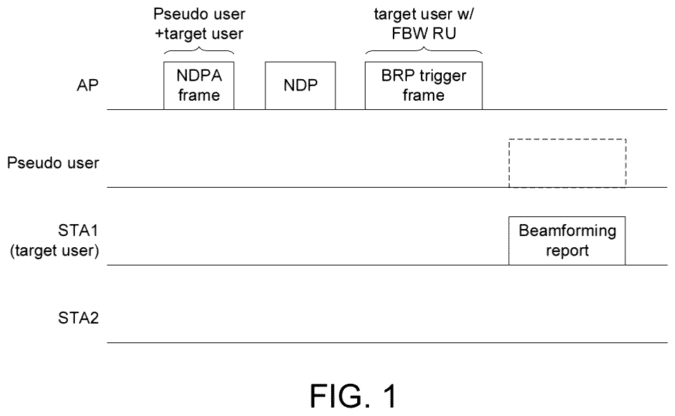

FIG. 1 shows a multi-user feedback procedure according to one embodiment of the application. That is, FIG. 1 shows a method for beamforming according to one embodiment of the application. The AP sends an NDPA frame, to indicate a pseudo user and a target station (i.e. a target user) (such as the station STA1 in FIG. 1) to prepare for channel estimation. Then, the AP sends an NDP to the pseudo user and the target station, such that the target station STA1 perform channel estimation wherein the pseudo user does not have to perform channel estimation because the pseudo user is “pseudo”. The AP sends a beamforming report poll (BRP) trigger frame to trigger the target station STA1 to feed back channel state information. The target station STA1 sends a beamforming report to the AP.

It should be noted that the NDPA frame, the BRP trigger frame, and the beamforming report may be MAC frames, which is not to limit the application.

### (2) Resource Unit (RU)

The resource unit is a frequency domain resource, and the resource unit includes one or more subcarriers. Currently, the following types of RUs are defined in a WLAN system: a 26-subcarrier RU (to be more specific, one RU includes 26 subcarriers), a 52-subcarrier RU (to be more specific, one RU includes 52 subcarriers), a 106-subcarrier RU (to be more specific, one RU includes 106 subcarriers), a 242-subcarrier RU (to be more specific, one RU includes 242 subcarriers), a 484-subcarrier RU (to be more specific, one RU includes 484 subcarriers), a 996-subcarrier RU (to be more specific, one RU includes 996 subcarriers), and the like.

Currently, channel bandwidths (CBWs) supported by the 802.11ax standard are 20 MHz, 40 MHz, 80 MHZ, 80+80 MHz (to be more specific, two channels with a bandwidth of 80 MHz are supported, and the two channels are non-contiguous and non-overlapping), and 160 MHz. Table 1 shows a total quantity of RUs in each channel bandwidth.

TABLE 1

| | CBW | CBW | CBW | CBW 160 and |
|---|---|---|---|---|
| RU type | 20 | 40 | 80 | CBW 80 + 80 |
| 26-subcarrier RU | 9 | 18 | 37 | 74 |
| 52-subcarrier RU | 4 | 8 | 16 | 32 |
| 106-subcarrier RU | 2 | 4 | 8 | 16 |
| 242-subcarrier RU | 1 | 2 | 4 | 8 |
| 484-subcarrier RU | N/A | 1 | 2 | 4 |
| 996-subcarrier RU | N/A | N/A | 1 | 2 |
| 2 × 996 subcarrier RU | N/A | N/A | N/A | 1 |

N/A: Not applicable

### (3) Segment

The beamforming report may be divided into eight segments. In this case, the channel state information included in the beamforming report is also divided into eight parts, and each segment carries one part of the channel state information.

The technical solutions of this application are applied to for example but not limited by, a WLAN or WiFi 6 (or next WiFi generations). A standard used for the WLAN may be an IEEE 802.11 standard such as an 802.11ac standard, an 802.11ax standard, or a next generation 802.11 standard. The technical solutions of this application are applicable to scenarios such as communication between an AP and a STA, communication between APs, and communication between STAs. In the embodiments of this application, the AP may be used as a beamformer, or may be used as a beamformee. The STA may be used as a beamformer, or may be used as a beamformee. The AP may be a wireless router, a wireless transceiver, a wireless switch, or the like. The STA has different names such as a subscriber unit, an access terminal, a mobile station, a mobile console, a mobile device, a terminal, and user equipment. During actual application, the STA may be a cellular phone, a smartphone, a wireless local loop (WLL), another handheld device that has a wireless local area network communication function, or a computer device.

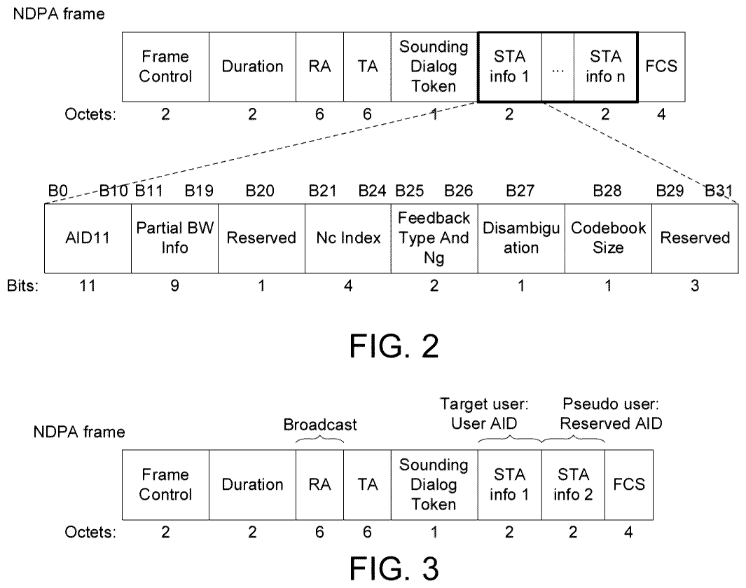

FIG. 2 is a schematic structural diagram of a common NDPA frame. As shown in FIG. 2, the NDPA frame includes a MAC header, a sounding dialog token field, one or more pieces of station information, and a frame check sequence (FCS) field.

The MAC header includes (1) a frame control field, used to indicate a type of the MAC frame; (2) a duration field, used to indicate duration of occupying a channel by the MAC frame and a corresponding acknowledgment frame; (3) a receiving address (RA) field, used to identify a receive end of the MAC frame; and (4) a transmitting address (TA) field, used to identify a transmit end of the MAC frame.

The NDP Announcement frame contains at least one STA info field. If the NDP Announcement frame contains only one STA Info field, then the RA field is set to the address of the STA that can provide feedback. If the NDP Announcement frame contains more than one STA Info field, then the RA field is set to the broadcast address.

The TA field is set to the address of the STA transmitting the NDP Announcement frame or the bandwidth signaling TA of the STA transmitting the NDP Announcement frame.

The station information may further include one or more of the following parameters: an association identifier (AID) (11 bits), partial bandwidth information (9 bits), a number of columns index (Nc index) (4 bits), a feedback type and an Ng (2 bits), a disambiguation bit (one bit) and a codebook size (one bit). The partial bandwidth information includes a resource unit start index and a resource unit end index.

The frame check sequence field is used to enable the receive end to detect whether a received MAC frame is correct.

Optionally, as shown in FIG. 2, the sounding dialog token field in the NDPA frame includes an NDPA type and a sounding dialog token number. The NDPA type is used to indicate a type of the NDPA frame, that is, indicate that the NDPA frame is a very high throughput (VHT) NDPA frame (that is, an NDPA frame in the 802.11ac standard), a high efficiency (HE) NDPA frame, a ranging NDPA frame, or an EHT NDPA frame. The sounding dialog token number is used to identify a sounding dialog. The sounding dialog token number subfield in the sounding dialog token field contains a value selected by the beamformer to identify the NDP Announcement frame.

In the STA Info field, the association identifier (AID) (11 bits) indicates 11-LSB Association ID. The partial bandwidth information contains RU start index subfield and RU end index subfield that indicates the first and the last 26-tone RU respectively for which the beamformer is requesting feedback. The Nc Index indicates the number of columns in the compressed beamforming feedback matrix subfield minus 1 if the feedback type field indicates MU type. The feedback type and Ng field indicates the compressed beamforming feedback type asked by the beamformer and the number of subcarrier grouped together in a feedback matrix. The codebook size field (and Ng) indicates the quantization resolution of compressed beamforming feedback matrix. The disambiguation field is set to 1 to prevent a non-HE/EHT VHT STA from wrongly identifying its AID in the HE/EHT NDP Announcement frame.

FIG. 3 shows a schematic structural diagram of an NDPA frame according to an embodiment of this application. As shown in FIG. 3, in beamforming, the AP sends the NDPA frame to the pseudo user and the target user (STA1). In order to send the NDPA frame to the pseudo user and the target user (STA1) from the AP, the NDPA frame includes the STA information 1 (the first STA information or said, the first user information) related to the target user and the STA information 2 (the second STA information or said, the second user information) related to the pseudo user. The STA information 1 indicates or uses the normal user AID in the AID field. The STA information 2 indicates or uses AID 0 (AP) or not-application (N/A) and/or reserved AID in the AID field. For example but not limited by, AID 2008-2042 or 2046 are N/A or reserved, and thus AID 2008-2042 or 2046 may be used in the AID filed of the STA information 2 to indicate the pseudo user. Also, the RA field of the NDPA frame is set to the broadcast address because the NDPA frame contains two STA information field.

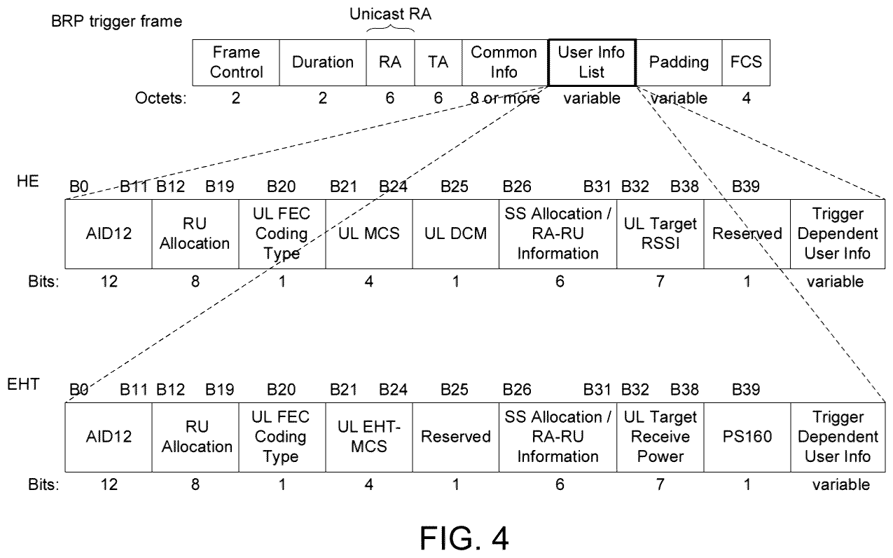

FIG. 4 is a schematic structural diagram of a BRP trigger frame according to an embodiment of this application. As shown in FIG. 4, the BRP trigger frame includes a MAC header (including the frame control field, the duration field, the receiving address (RA) field and the transmitting address (TA) field), common info (8 bits or more), a user info list (variable bits), padding information (variable bits) and an FCS field (4 bits). The common info includes some common information such as a trigger type and an uplink length. For content, refer to the 802.11 standard. Details are not described herein. The user info list includes one or more pieces of user information. The user information includes one or more of the following parameters: an AID field (12 bits), resource unit allocation (RU allocation) (8 bits), an uplink (UL) forward error correction (FEC) coding type (1 bit), an UL modulation and coding scheme (MCS) (4 bits), UL dual-carrier modulation (DCM) (1 bit), spatial stream (SS) allocation/random access resource unit (RA-RU) information (6 bits), an uplink target received signal strength indication (RSSI) (7 bits), a trigger dependent user info (variable bits), or one or more reserved bits. For meanings of the foregoing parameters, refer to the 802.11 standard. Details are not described herein.

Further, in FIG. 4, the RA field of the BRP trigger frame is set to the address of the non-AP STA of which the AID12 subfield of the User Info field contains the AID. If the trigger frame has more than one User Info field that is not a Special User Info field, the RA field is set to the broadcast address.

Also, the TA field of the BRP trigger frame is set to the address of the STA transmitting the trigger frame.

The Common Info field of the BRP trigger frame describes the information of the method that this trigger frame is transmitted with, including trigger type, UL length, bandwidth, . . . , etc.

Further, in the User Info List field of the BRP trigger frame, the AID field indicates 12-LSB Association ID; the RU Allocation subfield along with the UL BW subfield in the Common Info field identifies the size and the location of the RU; the UL FEC Coding Type subfield indicates the code type of the solicited HE/EHT TB PPDU; the UL FEC Coding Type subfield is set to 0 to indicate BCC and set to 1 to indicate LDPC; the UL HE/EHT-MCS subfield of the User Info field indicates the HE/EHT-MCS of the solicited HE/EHT TB PPDU; the UL DCM subfield of the User Info field indicates DCM of the solicited HE TB PPDU; The UL DCM subfield is reserved in EHT variant User Info field; the SS Allocation subfield of the User Info field indicates the spatial streams of the solicited HE/EHT TB PPDU; the UL Target received signal strength indication (RSSI) subfield indicates the expected receive signal power, measured at the AP's antenna connector and averaged over the antennas; the values of PS160 subfield indicates the 160 MHz segment in which the RU or MRU is located for 2×996-tone RU, 996+484-tone MRU, and 996+484+242-tone MRU; the Trigger Dependent User Info subfield in the User Info field is optionally present based on the value of the Trigger Type field

In one embodiment of the application, the BRP trigger frame is sent to the target STA, and thus the RA field of the BRP trigger frame is set to the unicast address.

In one embodiment of the application, the BRP trigger frame includes only one user info field which indicates the target user AID in the AID field.

In one embodiment of the application, in the RU allocation subfield of the user info of the BRP trigger frame, the RU allocation of the target user is set to the FBW (full bandwidth).

The following equation (1) shows sounding overhead calculation according to one embodiment of the application.

$$SndOverhead = ( \frac{Tb 1 usrSndDur}{SndPeriod 1} + \frac{Tb 1 usrSndDur}{SndPeriod 2} + \frac{Tb 2 usrSndDur - 2 * Tb 1 usrSndDur}{[ SndPeriod 1 , SndPeriod 2 ]} ) * 100 \% \qquad ( 1 )$$

In equation (1), the term “Tb1usrSndDur” indicates TB 1-user sounding FES duration with one target user and one pseudo user; the term “Tb2usrSndDur” indicates TB 2-user sounding FES duration with two target users; the term “SndPeriod1” indicates the sounding period of the user 1; the term “SndPeriod2” indicates the sounding period of the user 2; and the term “[SndPeriod1, SndPeriod2]” indicates the least common multiple (LCM) of “SndPeriod1” and “SndPeriod2”. Equation (1) is an equation based on a 2-user environment and only. The equation (1) will be more complicated in a 3 or 4-user environment.

Also, the following equation (2) shows prior sounding overhead calculation.

$$SndOverhead = \frac{Tb 2 usrSndDur}{SndPeriod 1} * 100 \% \qquad ( 2 )$$

In equation (2), it is assumed that “SndPeriod1” is smaller than “SndPeriod2”.

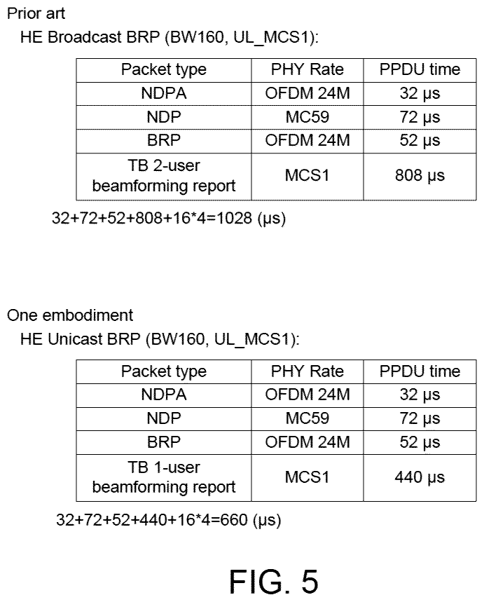

FIG. 5 shows comparison between the sounding overhead of the prior art and one embodiment of the application. In FIG. 5, a HE broadcast BRP (BW160, UL_MCS1) is taken as an example in calculating the sounding overhead, however the application is not limited by this.

As shown in FIG. 5, the NDPA frame has a PHY rate of OFDM 24M and PPDU time of 32 us. Others are so on.

The sounding overhead of the prior art is 808 (us); while the sounding overhead of one embodiment of the application is 440. Sounding overhead is more like an overall sounding FES duration vs. overall transceiving time statistics result. Furthermore, this 808 us and 440 us are the duration of HE compressed beamforming report for TB 2-user and TB 1-user respectively, and based on the beamforming report poll trigger frame RU_allocation=BW160 and UL_MCS=MCS1.

Thus, the overall time length for sounding FES in the prior art is 32+72+50+808+16*4=1028 (us); and the overall time length for sounding FES in one embodiment of the application is 32+72+50+440+16*4=660 (us). Thus, one embodiment of the application has a shorter total time length for sounding FES, compared with the prior art.

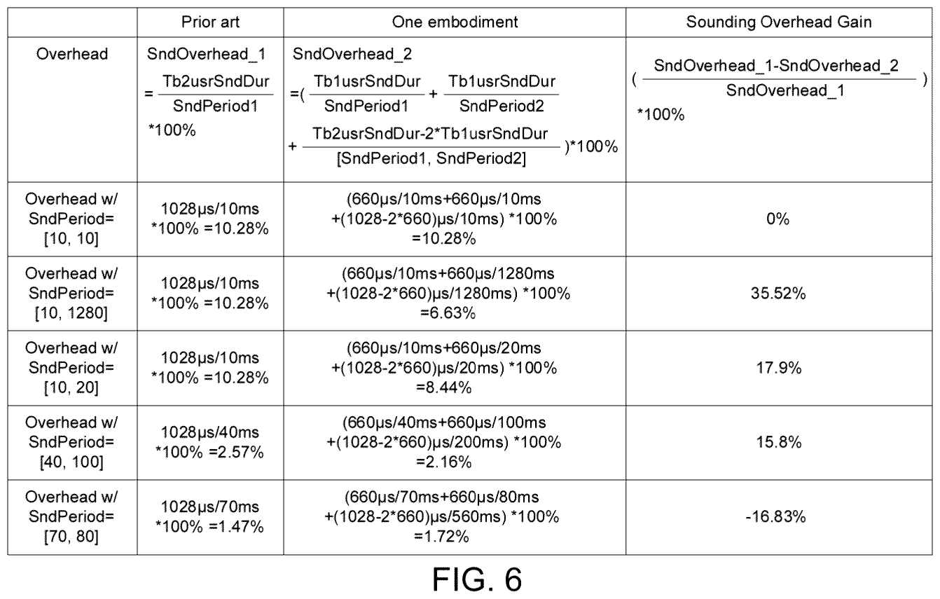

FIG. 6 shows estimation of sounding overhead of the prior art and one embodiment of the application. In FIG. 6, [10, 10] means that, to ensure the quality of beamforming, the sounding period of user 1 and user 2 are 10 (ms) and 10 (ms), respectively. Others are so on.

For example, when the sounding period of user 1 and user 2 are 10 (ms) and 10 (ms), ([10, 10]), the sounding overhead “SndOverhead_1” of prior art is: (1028 us/10 ms] *100%=10.28%; and the sounding overhead “SndOverhead_2” of one embodiment of the application is: [(660 us/10 ms)+ (660 us/10 ms)+ ((1028-2*660) us/10 ms)] *100%=10.28%. Thus, the sounding overhead gain is:

$$( \frac{SndOverhead\_ 1 - SndOverhead\_ 2}{SndOverhead\_ 1} ) * 100 \% = ( ( 10 \text{.28} - 10. 28 ) / 10.28 ) * 100 \% = 0 \% ,$$

wherein “SndOverhead_1” and “SndOverhead_2” indicates the sounding overhead of the prior art and one embodiment of the application.

Sometimes, one embodiment of the application may have worse sounding overhead than prior art. For example, when the sounding period of user 1 and user 2 are 70 (ms) and 80 (ms), ([70, 80]), the sounding overhead “SndOverhead_1” of prior art is: [1028(μs)/70 ms] *100%=1.47%; and the sounding overhead “SndOverhead_2” of one embodiment of the application is: [(660 us/70 ms)+ (660 us/80 ms)+ ((1028−2*660)us/560 ms)] *100%=1.72%. Thus, the sounding overhead gain is:

$$( \frac{SndOverhead\_ 1 - SndOverhead\_ 2}{SndOverhead\_ 1} ) * 100 \% = ( ( 1.47 - 1.72 ) / 1.47 ) * 100 \% = - 16.83 \% ,$$

which means one embodiment of the application may have worse sounding overhead than prior art. Thus, in order to achieve better sounding overhead, in one embodiment of the application, software and/or hardware can calculate the sounding overhead results of the prior art method and one embodiment of the application, and switch adaptively to select a better sounding overhead result.

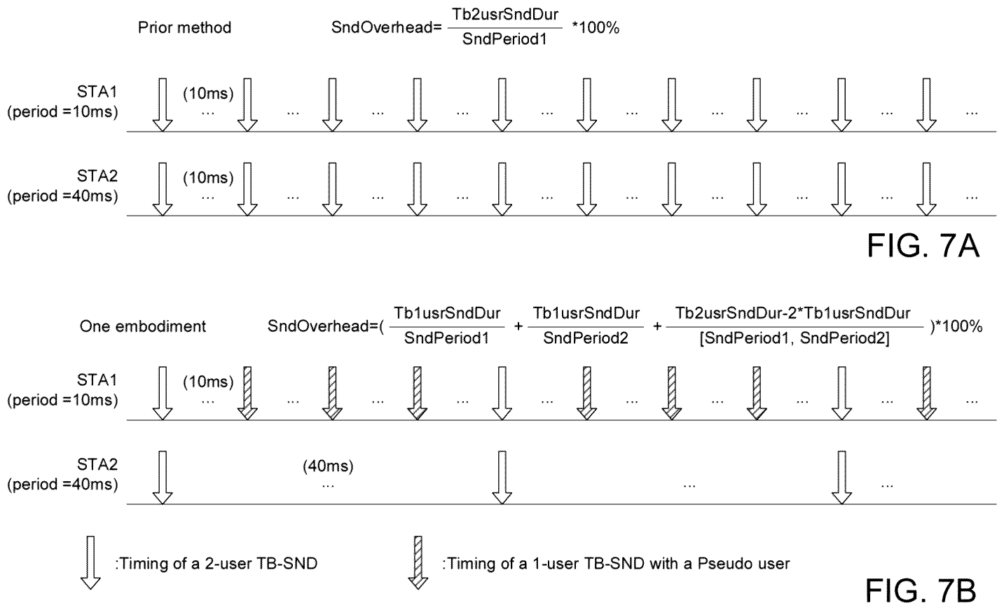

FIG. 7A and FIG. 7B show sounding overhead according to the prior art and one embodiment of the application. In FIG. 7A and FIG. 7B, it is assumed that the sounding period of STA1 and STA2 are 10 ms and 40 ms, respectively; and also the sounding FES duration can be neglected.

In FIG. 7A, within 40 ms period, there are overall five 2-user TB sounding.

In FIG. 7B, within 40 ms period, there are overall two 2-user TB sounding and three 1-user TB sounding.

Therefore, compared with FIG. 7A and FIG. 7B, it is known that one embodiment of the application has less sounding overhead.

The foregoing mainly describes the solutions provided in the embodiments of the application from a perspective of interaction between beamformers and beamformees. It may be understood that, to implement the foregoing functions, the beamformer and/or the beamformee includes corresponding hardware structures and/or software modules for performing the functions. A person skilled in the art should easily be aware that, in combination with units and algorithm steps of the examples described in the embodiments disclosed in this specification, this application may be implemented in a hardware form or in a form of combining hardware with computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In one embodiment of the application, the beamforming apparatus and/or the beamforming devices may be divided into function modules based on the foregoing method examples. For example, each function module may be obtained through division based on each corresponding function, or two or more functions may be integrated into one processing module. The integrated module may be implemented in a form of hardware, or may be implemented in a form of a software function module. It should be noted that, in the embodiments of this application, division into modules is an example, and is merely logical function division. During actual implementation, another division manner may be used. An example in which each function module is obtained through division based on each corresponding function is used below for description.

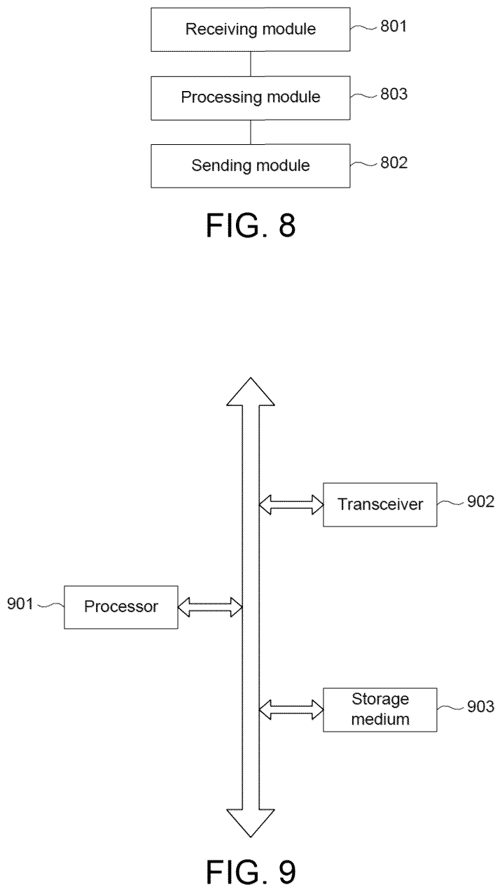

FIG. 8 is a schematic structural diagram of a communications apparatus according to an embodiment of this application. As shown in FIG. 8, the communications apparatus includes a receiving module 801, a sending module 802, and a processing module 803. The receiving module 801 and the sending module 802 may be also referred as a transceiver.

In an implementation, if the communications apparatus is used as a beamformer, the processing module 803 is configured to generate a NDPA frame, a NDP frame and a BRP trigger frame, as described above. The sending module 802 is configured to send the NDPA frame, the NDP frame and the BRP trigger frame generated by the processing module 803. The receiving module 801 is configured to receive a beamforming report sent by a beamformee.

In an implementation, if the communications apparatus is used as a beamformee, the receiving module 801 is configured to receive a NDPA frame, a NDP frame and a BRP trigger frame from a beamformer. The processing module 803 is configured to generate a beamforming report. The sending module 802 is configured to send the beamforming report to a beamformer.

The communications apparatus provided in the embodiments of this application may be implemented in a plurality of product forms. For example, the communications apparatus may be configured as a general-purpose processing system. For another example, the communications apparatus may be implemented using a general bus architecture. For another example, the communications apparatus may be implemented by an application-specific integrated circuit (ASIC). The following provides several possible product forms of the communications apparatus in the embodiments of this application. It should be understood that the following product forms are merely examples, and do not limit the possible product forms of the communications apparatus in the embodiments of this application.

FIG. 9 is a structural diagram of a possible product form of a communications apparatus according to an embodiment of this application.

In a possible product form, the communications apparatus in this embodiment of this application may be a communications device, and the communications device includes a processor 901 and a transceiver 902. Optionally, the communications device further includes a storage medium 903. The processor 901, the transceiver 902 and/or the storage medium 903 are configured to perform the beamforming methods shown above.

In another possible product form, the communications apparatus in this embodiment of this application may be alternatively implemented by a general-purpose processor, that is, implemented by a commonly known chip. In another possible product form, the communications apparatus in this embodiment of this application may be alternatively implemented using the following circuits or components: one or more field programmable gate arrays (FPGA), a programmable logic device (PLD), a controller, a state machine, gate logic, a discrete hardware component, any other suitable circuit, or any combination of circuits that can perform various functions described in this application.

One embodiment of the application is designed to work with all STAs (stations or devices) that come after Wi-Fi 5. It achieves compatibility by using TB-PPDUs (Trigger-Based Protocol Data Units) as explicit feedback.

One embodiment of the application involves “TB-Sounding” which involves triggering and gathering information from devices in the network. One embodiment of the application introduces the concept of a “pseudo user” within TB-Sounding. By introducing the pseudo user, the beamformer obtains Multi-User (MU) type explicit feedback from a single user (a target user) during beamforming.

In one embodiment of the application, the NDPA frame is used to carry one or more pseudo users to notify one or more target users that the TB-sounding sequence is initiated.

One embodiment of the application is versatile and can be applied to both single-link and multi-link scenarios, including Multi-link operation (MLO) which indicates that one embodiment of the invention is capable of handling scenarios involving multiple links simultaneously.

One embodiment of the invention is not limited to a specific Wi-Fi generation. One embodiment of the invention addresses Wi-Fi generations beyond Wi-Fi 5, including Wi-Fi 6, Wi-Fi 7, Wi-Fi 8, and so on. The technology or methodology proposed in one embodiment of the invention is forward-looking and intended to be compatible with future Wi-Fi standards. In summary, this invention involves a communication protocol or method that ensures compatibility with newer Wi-Fi standards, incorporates a mechanism for obtaining explicit feedback from users, and is flexible enough to work in various scenarios, including single and multi-link environments.

Although this application is described with reference to the embodiments, in a process of implementing this application that claims protection, a person skilled in the art may understand and implement another variation of the disclosed embodiments by viewing the accompanying drawings, disclosed content, and the appended claims. In the claims, “comprising” does not exclude another component or another step, and “a” or “one” does not exclude a case of plurality. A single processor or another unit may implement several functions enumerated in the claims. Some measures are recorded in dependent claims that are different from each other, but this does not mean that these measures cannot be combined to produce a better effect.

Although this application is described with reference to example features and the embodiments thereof, it is clear that various modifications and combinations may be made to this application without departing from the spirit and scope of this application. Correspondingly, the specification and accompanying drawings are merely example descriptions of this application defined by the appended claims, and are considered as any of or all modifications, variations, combinations, or equivalents that cover the scope of this application. It is clear that, a person skilled in the art can make various modifications and variations to this application without departing from the spirit and scope of this application. This application is intended to cover these modifications and variations of this application provided that they fall within the scope of the claims of this application and their equivalent technologies.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A beamforming method comprising:
sending a null data packet announcement (NDPA) frame from a beamformer to a pseudo user and a target user to indicate the target user to prepare for channel estimation;
sending a null data packet (NDP) from the beamformer to the target user and performing channel estimation by the target user based on the NDP to determine channel state information;
sending a beamforming report poll (BRP) trigger frame from the beamformer to the target user to trigger the target user to feed back channel state information; and
sending from the target user a beamforming report to the beamformer, wherein the beamforming report including the channel state information.

2. The beamforming method according to claim 1, wherein
the NDPA frame includes a first user information and a second user information;
the first user information, related to the target user, indicates a normal user association identifier (AID); and
the second user information, related to the pseudo user, indicates AID 0 or not-application (N/A) and/or reserved AID.

3. The beamforming method according to claim 2, wherein AID 2008-2042 or 2046 are N/A or reserved, which are used in the second user information to indicate the pseudo user.

4. The beamforming method according to claim 1, wherein a receiving address information of the NDPA frame is set to a broadcast address.

5. The beamforming method according to claim 1, wherein a receiving address information of the BRP trigger frame is set to a unicast address.

6. The beamforming method according to claim 1, wherein in a RU allocation subfield of a user information of the BRP trigger frame, RU allocation of the target user is set to full bandwidth.

7. The beamforming method according to claim 1, wherein a sounding overhead SndOverhead is as follows:
$$SndOverhead = ( \frac{Tb 1 usrSndDur}{SndPeriod 1} + \frac{Tb 1 usrSndDur}{SndPeriod 2} + \frac{Tb 2 usrSndDur - 2 * Tb 1 usrSndDur}{[ SndPeriod 1 , SndPeriod 2 ]} ) * 100 \% ,$$
wherein the term “Tb1usrSndDur” indicates trigger based (TB) 1-user sounding FES duration with the target user and the pseudo user; the term “Tb2usrSndDur” indicates TB 2-user sounding FES duration with the target user and another target user; the term “SndPeriod1” indicates a sounding period of the target user; the term “SndPeriod2” indicates a sounding period of the another target user; and the term “[SndPeriod1, SndPeriod2]” indicates the least common multiple (LCM) of “SndPeriod1” and “SndPeriod2”.

8. A beamforming device comprising:
a processor; and
a transceiver coupled to the processor,
wherein the processor and the transceiver are configured for:
sending a null data packet announcement (NDPA) frame to a pseudo user and a target user to indicate the target user to prepare for channel estimation;
sending a null data packet (NDP) to the target user and performing channel estimation by the target user based on the NDP to determine channel state information;
sending a beamforming report poll (BRP) trigger frame to the target user to trigger the target user to feed back channel state information; and
receiving from the target user a beamforming report, wherein the beamforming report including the channel state information.

9. The beamforming device according to claim 8, wherein
the NDPA frame includes a first user information and a second user information;
the first user information, related to the target user, indicates a normal user association identifier (AID); and
the second user information, related to the pseudo user, indicates AID 0 or not-application (N/A) and/or reserved AID.

10. The beamforming device according to claim 9, wherein AID 2008-2042 or 2046 are N/A or reserved, which are used in the second user information to indicate the pseudo user.

11. The beamforming device according to claim 8, wherein a receiving address information of the NDPA frame is set to a broadcast address.

12. The beamforming device according to claim 8, wherein a receiving address information of the BRP trigger frame is set to a unicast address.

13. The beamforming device according to claim 8, wherein in a RU allocation subfield of a user information of the BRP trigger frame, RU allocation of the target user is set to full bandwidth.

14. The beamforming device according to claim 8, wherein a sounding overhead SndOverhead is as follows:
$$SndOverhead = ( \frac{Tb 1 usrSndDur}{SndPeriod 1} + \frac{Tb 1 usrSndDur}{SndPeriod 2} + \frac{Tb 2 usrSndDur - 2 * Tb 1 usrSndDur}{[ SndPeriod 1 , SndPeriod 2 ]} ) * 100 \% ,$$
wherein the term “Tb1usrSndDur” indicates trigger based (TB) 1-user sounding FES duration with the target user and the pseudo user; the term “Tb2usrSndDur” indicates TB 2-user sounding FES duration with the target user and another target user; the term “SndPeriod1” indicates a sounding period of the target user; the term “SndPeriod2” indicates a sounding period of the another target user; and the term “[SndPeriod1, SndPeriod2]” indicates the least common multiple (LCM) of “SndPeriod1” and “SndPeriod2”.
